(19) United States
(12) Patent Application Publication
(10) Pub. No.: US 2025/0190467 A1
(43) Pub. Date: Jun. 12, 2025

(54) METHOD FOR EVALUATING LANGUAGE MODEL AND ELECTRONIC DEVICE

(71) Applicant: PEGATRON CORPORATION, TAIPEI CITY (TW)

(72) Inventor: Wan-Yun Bao, Taipei City (TW)

(73) Assignee: PEGATRON CORPORATION, TAIPEI CITY (TW)

(21) Appl. No.: 18/812,799

(22) Filed: Aug. 22, 2024

(30) Foreign Application Priority Data
Dec. 11, 2023 (TW) 112148170

(51) Int. Cl. G06F 16/33; G06F 16/338

(52) U.S. Cl. CPC G06F 16/3344; G06F 16/338

(57) ABSTRACT

Embodiments of the disclosure provide a method for evaluating a language model and an electronic device. The method includes: obtaining a prompt and a reference query syntax; obtaining a first reference query result by querying a database with the reference query syntax and organizing the first reference query result into a second reference query result presented in a preset format based on the preset format; obtaining a first query syntax generated by a first language model in response to the prompt; obtaining a first query result by querying the database with the first query syntax and organizing the first query result into a second query result presented in the preset format based on the preset format; evaluating a first validity of the first query syntax provided by the first language model based on whether the second query result completely includes the second reference query result.

### CROSS-REFERENCE TO RELATED APPLICATION

This application claims the priority benefit of Taiwan application serial no. 112148170, filed on Dec. 11, 2023. The entirety of the above-mentioned patent application is hereby incorporated by reference herein and made a part of specification.

### BACKGROUND

### Technical Field

The disclosure relates to a technique for evaluating an artificial intelligence model, and in particular, to a method for evaluating a language model and an electronic device.

### Description of Related Art

There are many large databases in real life, such as a production line database with historical output and yield data, a health insurance database for a government department, an inquiry database with a raw material historical price for an enterprise purchasing department, etc.

For users, if they may obtain accurate database query syntax (such as Structured Query Language (SQL), MongoDB, etc.) via a language model, work efficiency is significantly improved and the threshold for staff to learn program compilation is lowered.

Through a well-designed prompt, the language model may robustly generate a suitable SQL syntax, and this behavior may be called text-to-SQL. The main task of text-to-SQL is to convert questions presented in natural language into SQL syntax that the machine may understand and query the database. This technique may effectively assist users and the public in querying a massive database. Moreover, it also allows non-expert users who generally may not write programs to conveniently query the contents of the database through natural language.

In prior art, there are already many language models (such as OpenAI ChatGPT GPT-3, GPT-4, LLaMa-13B, LLaMA-65B, etc.) that may generate database query syntax in response to a prompt, but not every language model has the correct database query syntax to get the desired data from the database.

Therefore, for those skilled in the art, how to design a mechanism that may more appropriately evaluate the answers provided by different language models is an important issue.

### SUMMARY

Accordingly, the disclosure provides a method for evaluating a language model and an electronic device that may be used to solve the above technical issues.

An embodiment of the disclosure provides a method for evaluating a language model executed by an electronic device. The method includes: obtaining a prompt and a reference query syntax corresponding to the prompt; obtaining a first reference query result by querying a database with the reference query syntax and organizing the first reference query result into a second reference query result presented in a preset format based on the preset format; obtaining a first query syntax generated by a first language model in response to the prompt; obtaining a first query result by querying the database with the first query syntax and organizing the first query result into a second query result presented in the preset format based on the preset format; evaluating a first validity of the first query syntax provided by the first language model based on whether the second query result completely includes the second reference query result.

An embodiment of the disclosure provides an electronic device including a storage circuit and a processor. The storage circuit stores a program code. The processor is coupled to the storage circuit and accesses the program code to execute: obtaining a prompt and a reference query syntax corresponding to the prompt; obtaining a first reference query result by querying a database with the reference query syntax and organizing the first reference query result into a second reference query result presented in a preset format based on the preset format; obtaining a first query syntax generated by a first language model in response to the prompt; obtaining a first query result by querying the database with the first query syntax and organizing the first query result into a second query result presented in the preset format based on the preset format; evaluating a first validity of the first query syntax provided by the first language model based on whether the second query result completely includes the second reference query result.

Based on the above, the method provided in an embodiment of the disclosure may better evaluate whether the language model may provide a suitable query syntax in response to the prompt.

### BRIEF DESCRIPTION OF THE DRAWINGS

FIG. 1 is a schematic diagram of evaluating a language model based on the concept of exact match rate.

FIG. 2 is a schematic diagram of evaluating a language model based on the concept of unordered matching.

FIG. 3 is a schematic diagram of evaluating a language model based on the concept of execution result match.

FIG. 4 is a schematic diagram of the evaluation language models according to FIG. 1 and FIG. 2.

FIG. 5 is a schematic diagram of the evaluation language model according to FIG. 3.

FIG. 6 is a schematic diagram of an electronic device according to an embodiment of the disclosure.

FIG. 7 is a flowchart of a method for evaluating a language model according to an embodiment of the disclosure.

FIG. 8 is a schematic diagram of evaluating a language model according to an embodiment of the disclosure.

FIG. 9 is a flowchart of a method for evaluating a language model according to an embodiment of the disclosure.

### DESCRIPTION OF THE EMBODIMENTS

There are a plurality of mechanisms in the art that may be used to evaluate database query syntax provided by different language models, such as exact match rate, unordered match, and execution result match, etc. However, none of these mechanisms may properly evaluate the database query syntax provided by different language models in response to a prompt.

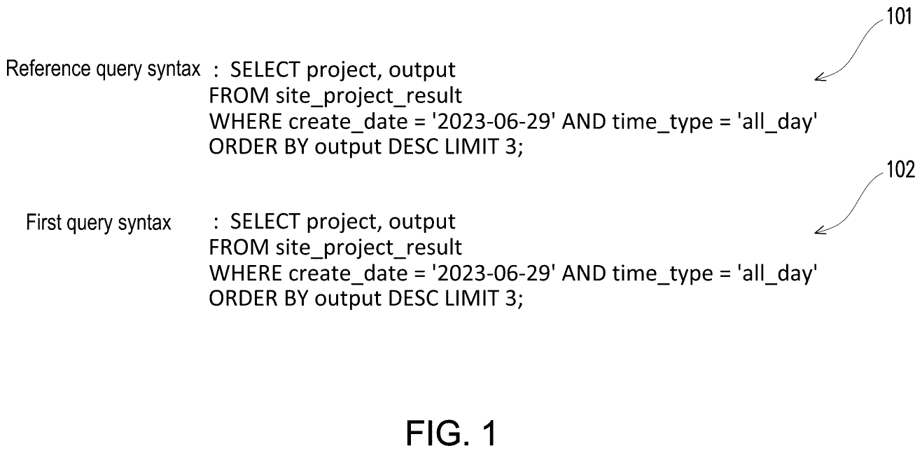

For example, in the case of FIG. 1 to FIG. 3 below, the designer may provide a prompt to a language model, and the prompt may be used to control the language model to generate a database query syntax (hereinafter referred to as the first query syntax). Moreover, the designer may further design a correct database query syntax (hereinafter referred to as the reference query syntax) for obtaining the desired data from the database for the above prompt based on their own knowledge.

In the case of FIG. 1 to FIG. 3, it may be seen that the above knowledge evaluation mechanism evaluates the characteristics of the database query syntax provided by the language model, which will be further explained below. In addition, in order to make the concept of the disclosure clearer, various query syntaxes mentioned below are all assumed to be SQL syntaxes. In other embodiments, the concepts of the disclosure herein are also applicable to other database query syntaxes, such as MongoDB, but may be not limited thereto.

FIG. 1 is a schematic diagram of evaluating a language model based on the concept of exact match rate. In FIG. 1, it is assumed that a reference query syntax 101 designed by a designer in response to a certain prompt and a first query syntax 102 provided by a language model (to be evaluated) in response to the same prompt have the content shown.

In the concept of exact match rate, the first query syntax 102 provided by the language model is evaluated as valid only in a case that the contents of the reference query syntax 101 and the first query syntax 102 are exactly the same. In other words, as long as the content of the reference query syntax 101 is slightly different from that of the first query syntax 102, the first query syntax 102 provided by the language model is evaluated as invalid (even though the first query syntax 102 may be used to obtain the retrieved data from the database).

It may be seen from FIG. 1 that since the contents of the reference query syntax 101 and the first query syntax 102 are exactly the same, the first query syntax 102 is evaluated as valid in the concept of exact match rate.

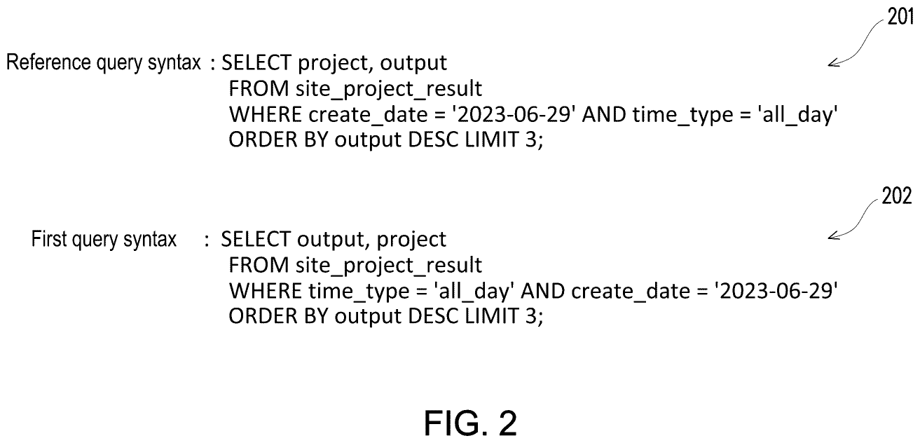

FIG. 2 is a schematic diagram of evaluating a language model based on the concept of unordered matching. In FIG. 2, it is assumed that a reference query syntax 201 designed by a designer in response to a certain prompt and a first query syntax 202 provided by a language model (to be evaluated) in response to the same prompt have the content shown.

In the concept of unordered matching, if the content of the first query syntax 202 may be understood to correspond to the rearranged result of the reference query syntax 201, then even if the reference query syntax 201 and the first query syntax 202 are not exactly the same, the first query syntax 202 provided by the language model is still evaluated as valid.

It may be seen from FIG. 2 that the contents recited in the first lines and the third lines of the reference query syntax 201 and the first query syntax 202 are not the same. Specifically, the first line of the reference query syntax 201 recites “SELECT project, output”, and the first line of the first query syntax 202 recites “SELECT output, project”. In other words, the first rows of the reference query syntax 201 and the first query syntax 202 recite the two fields “project” and “output” in different orders.

Moreover, the third line of the reference query syntax 201 recites “WHERE create_date=‘2023-06-29’ AND time_type=‘all_day’”, and the third line of the first query syntax 202 recites “WHERE time_type=‘all_day’ AND create_date=‘2023-06-29’”. In other words, the third rows of the reference query syntax 201 and the first query syntax 202 recite the two fields “create_date=‘2023-06-29’” and “time_type=‘all_day’” in different orders.

It may be seen from the above that although the contents recited in the first lines and the third lines of the reference query syntax 201 and the first query syntax 202 are different, the content of the first query syntax 202 may be understood to correspond to the rearranged result of the reference query syntax 201. Therefore, in the concept of unordered matching, the first query syntax 202 is evaluated as valid.

However, even if the syntax content used is different or in a different order when querying the database, it does not necessarily mean that the correct data may not be retrieved from the database. Therefore, the evaluation mechanisms of FIG. 1 and FIG. 2 are substantially unable to properly evaluate the language model.

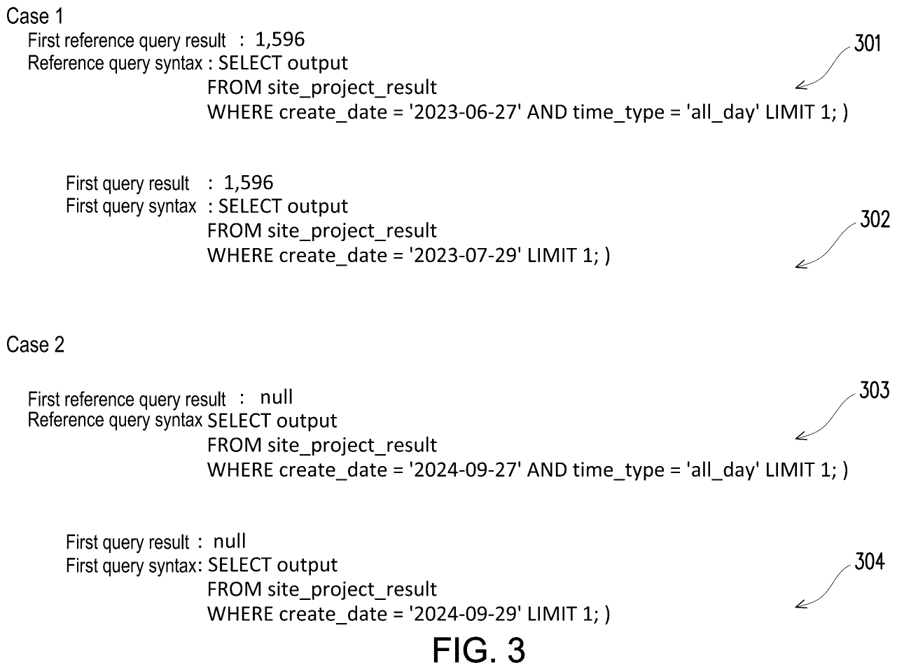

FIG. 3 is a schematic diagram of evaluating a language model based on the concept of execution result match. In case 1 of FIG. 3, it is assumed that a reference query syntax 301 designed by a designer in response to a certain prompt and a first query syntax 302 provided by a language model (to be evaluated) in response to the same prompt have the content shown.

In case 1, it is assumed that the query result (hereinafter referred to as the first reference query result) obtained after the reference query syntax 301 is used to query the database is 1596, and the query result obtained after the first query syntax 302 is used to query the database (hereinafter referred to as the first query result) is also 1596.

In the concept of execution result match, since the first reference query result in case 1 is the same as the first query result, the first query syntax 302 in case 1 is evaluated as valid.

Moreover, in case 2 of FIG. 3, it is assumed that a reference query syntax 303 designed by a designer in response to a certain prompt and a first query syntax 304 provided by a language model (to be evaluated) in response to the same prompt have the content shown.

In case 2 of FIG. 3, it is assumed that the first reference query result obtained after the reference query syntax 303 is used to query the database is null (that is, the data may not be obtained, or the data to be queried does not exist), and the first query result obtained after the first query syntax 304 is used to query the database is also null.

In the concept of execution result match, since the first reference query result in case 2 is the same as the first query result, the first query syntax 304 in case 2 is still evaluated as valid. In other words, when neither the reference query syntax 303 nor the first query syntax 304 may be used to obtain data, the first query syntax 304 is still mistakenly determined to be valid. In this case, there is a possibility that the first query syntax 304 is mistakenly determined to be valid. It may therefore be seen that the evaluation mechanism of FIG. 3 is substantially unable to evaluate the language model appropriately.

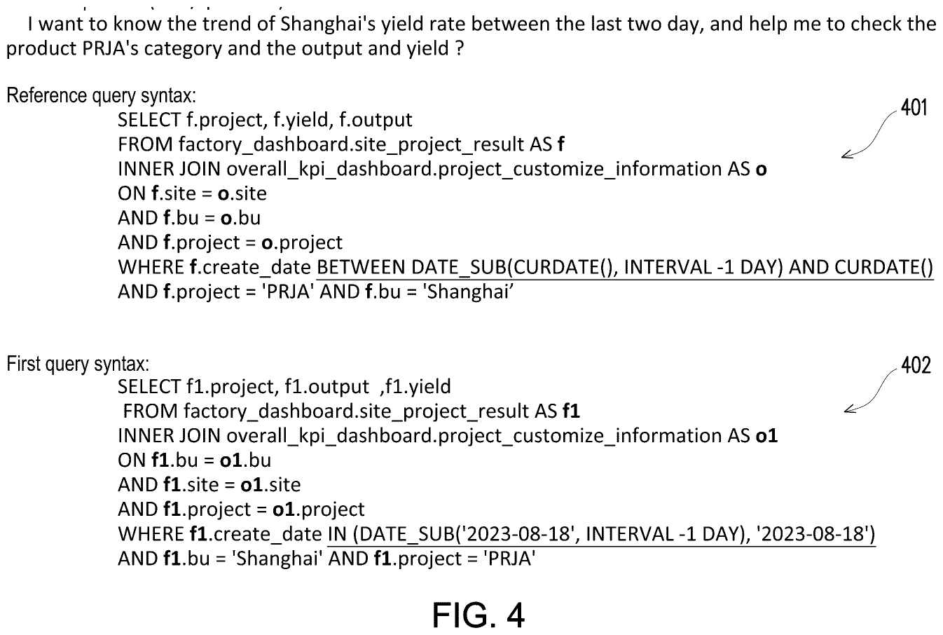

FIG. 4 is a schematic diagram of the evaluation language model according to FIG. 1 and FIG. 2. In FIG. 4, it is assumed that the question raised by the user is “I want to know the trend of Shanghai's yield rate between the last two days, and help me check the product PRJA's category and the output and yield?” In this case, the designer (for example, an engineer managing the database) may design the prompt and a corresponding reference query syntax 401 accordingly. Additionally, the same prompt may be fed into a language model (to be evaluated) (e.g., ChatGPT), and a first query syntax 402 is provided accordingly.

In FIG. 4, the differences between the reference query syntax 401 and the first query syntax 402 are presented in bold. Based on the evaluation mechanisms of FIG. 1 and FIG. 2, the first query syntax 402 should not be determined to be valid. However, after the reference query syntax 401 and the first query syntax 402 are actually used to query the database, the same data may actually be obtained. In other words, the first query syntax 402 should substantially be determined to be valid.

It may therefore be seen that the mechanisms of FIG. 1 and FIG. 2 may not correctly evaluate the first query syntax 402 in FIG. 4.

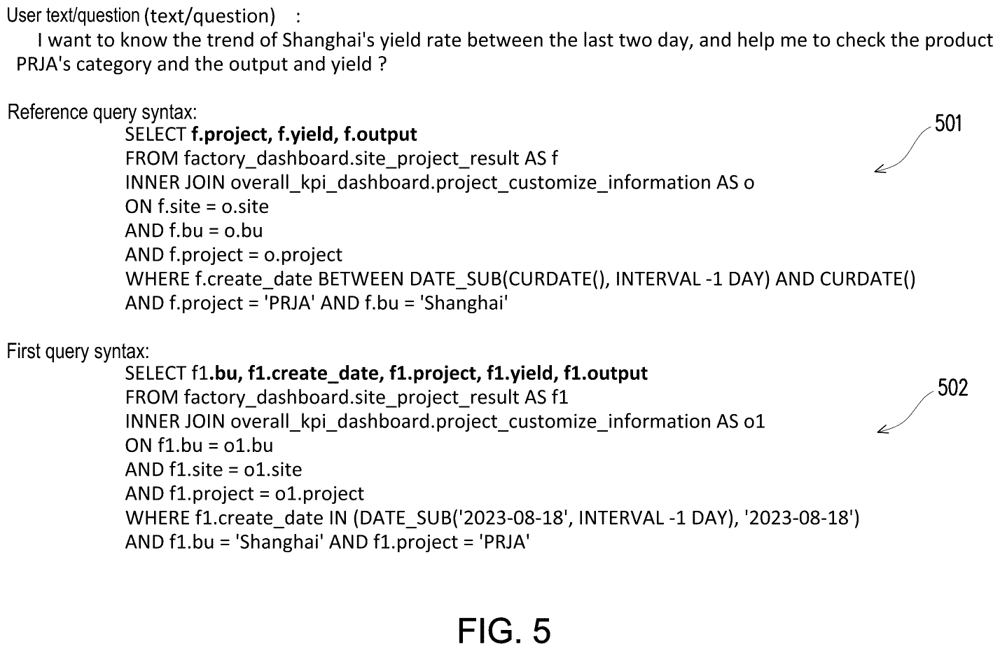

FIG. 5 is a schematic diagram of the evaluation language model according to FIG. 3. In FIG. 5, it is assumed that the question raised by the user is “I want to know the trend of Shanghai's yield rate between the last two days, and help me check the product PRJA's category and the output and yield?” In this case, the designer (for example, an engineer managing the database) may design the prompt and a corresponding reference query syntax 501 accordingly. Additionally, the same prompt may be fed into a language model (to be evaluated) (e.g., ChatGPT), and a first query syntax 502 is provided accordingly.

In the case of FIG. 5, if the reference query syntax 501 is used to query the database, relevant data corresponding to the three fields of “project”, “yield”, and “output” may be obtained. In addition, if the first query syntax 502 is used to query the database, relevant data corresponding to the five fields “bu”, “create_date”, “project”, “yield”, and “output” may be obtained. In other words, in addition to including the first reference query result obtained after the reference query syntax 501 is used to query the database, the first query result obtained after the first query syntax 502 is used to query the database also provides relevant data of “bu” and “create_date”.

It may be seen that the first query syntax 502 may substantially be used to obtain the desired data from the database. However, since the first query result is not the same as the first reference query result, the first query syntax 502 is not determined as valid in the mechanism of FIG. 3. In other words, the mechanism of FIG. 3 may not correctly evaluate the first query syntax 502 in FIG. 5.

The disclosure provides a method for evaluating a language model that may be used to more accurately evaluate a query syntax provided by a language model, and the relevant details thereof are described as follows.

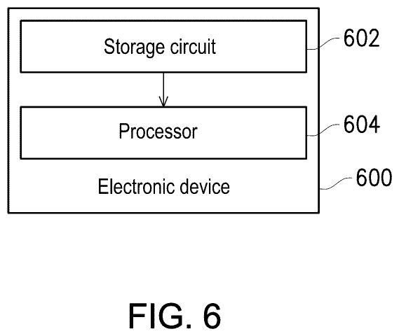

FIG. 6 is a schematic diagram of an electronic device according to an embodiment of the disclosure. In different embodiments, an electronic device 600 may be implemented as various smart devices and/or computer devices, for example, but may be not limited thereto.

In FIG. 6, the electronic device 600 includes a storage circuit 602 and a processor 604.

The storage circuit 602 is, for example, any type of fixed or removable random-access memory (RAM), read-only memory (ROM), flash memory, hard disk, or other similar devices or a combination of these devices, and may be used to record a plurality of program codes or modules.

The processor 604 is coupled to the storage circuit 602, and may be a general-purpose processor, special-purpose processor, conventional processor, digital signal processor, a plurality of microprocessors, one or a plurality of microprocessors combined with digital signal processor cores, a controller, a microcontroller, an application-specific integrated circuit (ASIC), a field-programmable gate array (FPGA) circuit, any other type of integrated circuit, state machine, Advanced RISC Machine (ARM)-based processor, and the like.

In an embodiment of the disclosure, the processor 604 may access a module and a program code recorded in the storage circuit 602 to implement the method for evaluating the language model provided in the disclosure, the details of which are described in detail below.

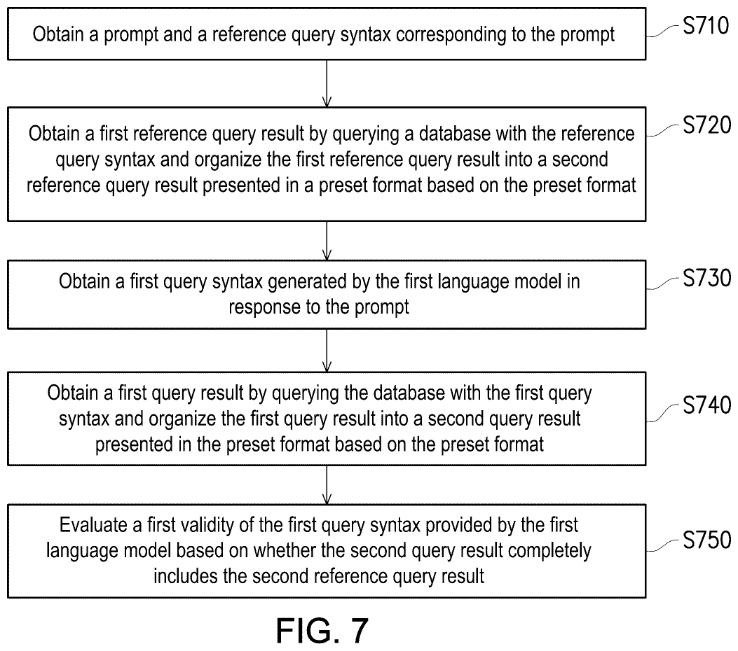

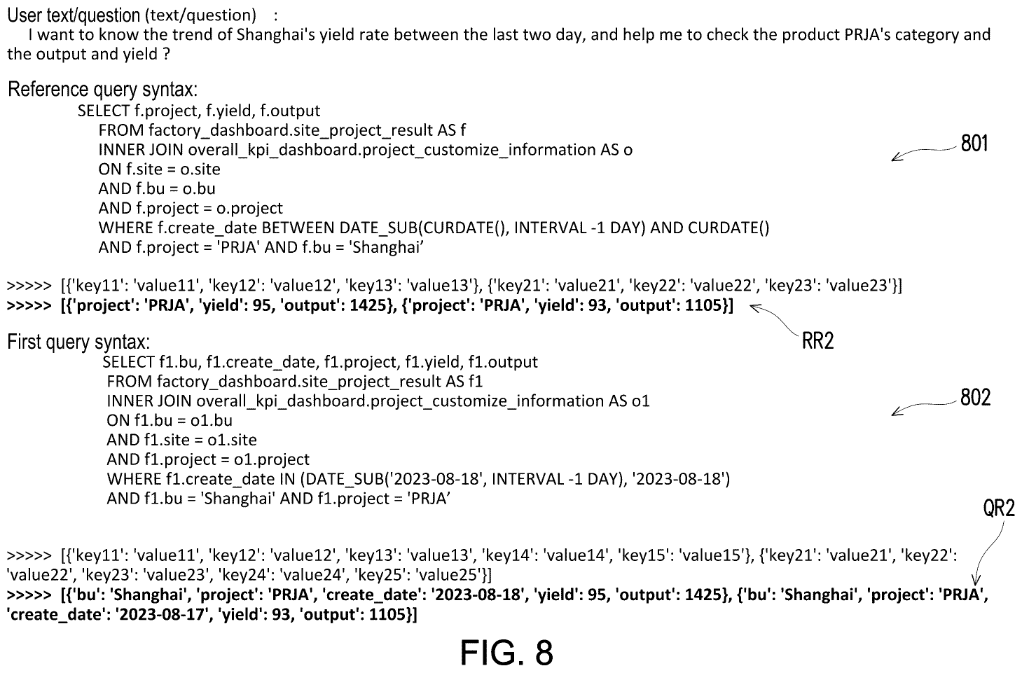

FIG. 7 is a flowchart of a method for evaluating a language model according to an embodiment of the disclosure. The method of the present embodiment may be performed by the electronic device 600 of FIG. 6, and the details of each step of FIG. 7 are described below with the elements shown in FIG. 6. In addition, in order to make the concept of the present application easier to understand, the following is supplemented by the case of FIG. 8 for explanation, wherein FIG. 8 is a schematic diagram of an evaluation language model according to an embodiment of the disclosure.

First, in step S710, the processor 604 obtains a prompt and a reference query syntax 801 corresponding to the prompt. As mentioned before, the prompt is, for example, a prompt designed by a designer (such as an engineer managing/operating a database) in response to a user question, and the reference query syntax 801 is, for example, a correct database query syntax designed by the designer to query the database in response to the prompt.

In the case of FIG. 8, the question of the user is, for example, “I want to know the trend of Shanghai's yield rate between the last two days, and help me check the product PRJA's category and the output and yield?” and for example, the designer may prepare the prompt accordingly and design the reference query syntax 801 to have the content shown in FIG. 8, but may be not limited thereto.

In step S720, the processor 604 obtains a first reference query result (hereinafter referred to as RR1) by querying a database with the reference query syntax 801, and the first reference query result is organized into a second reference query result RR2 presented in a preset format based on the preset format.

As may be seen from the first line of the reference query syntax 801, the reference query syntax 801 may be used to query related data corresponding to three fields such as “project”, “yield”, and “output”. In addition, it may be seen from the second line from the last of the reference query syntax 801 that the date queried is the day of the query and the day before the day of the query.

In an embodiment, it is assumed that the relevant data of “project”, “yield”, and “output” corresponding to the day of the query are queried as “PRJA”, “95”, and “1425” respectively. In addition, it is assumed that the relevant data of “project”, “yield”, and “output” corresponding to the day before the query day are queried as “PRJA”, “93”, and “1105” respectively. In this case, the processor 604 may determine the above data obtained by query as the first reference query result RR1 in step S720.

Then, the processor 604 may organize the first reference query result RR1 into a second reference query result RR2 presented in a preset format based on the preset format.

In an embodiment of the disclosure, the second reference query result RR2 presented in the preset format may, for example, include one or a plurality of reference data combinations, and each of the reference data combinations includes a first reference query target and a first reference data corresponding to the first reference query target.

In an embodiment, the default format is, for example, the “{key:value}” format (the key may be understood as corresponding to the first reference query target, and the value may be understood as corresponding to the first reference data}), such as “[{‘key11’: ‘value11’, ‘key12’: ‘value12’, ‘key13’: ‘value13’}, {‘key21’: ‘value21’, ‘key22’: ‘value22’, ‘key23’: ‘value23’}]” shown in FIG. 8, but may be not limited thereto.

In this case, the second reference query result RR2 presented in the preset format correspondingly has the format shown in FIG. 8, such as “[{‘project’: ‘PRJA’, ‘yield’: 95, ‘output’: 1425}, {‘project’: ‘PRJA’, ‘yield’: 93, ‘output’: 1105}]”, but may be not limited thereto.

In step S730, the processor 604 obtains the first query syntax 802 generated by a first language model in response to a prompt.

In an embodiment, the first language model is, for example, a language model to be evaluated (such as ChatGPT), and for example, the processor 604 may input the prompt into the first language model to trigger the first language model to provide the corresponding first query syntax 802 in response to the prompt.

In step S740, the processor 604 obtains the first query result (hereinafter referred to as QR1) by querying the database with the first query syntax 802, and organizes the first query result QR1 into a second query result QR2 presented in the preset format based on the preset format.

As may be seen from the first line of the first query syntax 802, for example, the first query syntax 802 may be used to query relevant data corresponding to five fields such as “bu”, “project”, “create_date”, “yield”, and “output”. In addition, it may be seen from the second last line of the first query syntax 802 that the date of the query is “2023-08-18” (for example, the day of the query) and the day before “2023-08-18”.

In an embodiment, it is assumed that the relevant data of “bu”, “project”, “create_date”, “yield”, and “output” corresponding to “2023-08-18” are respectively queried as “Shanghai”, “PRJA”, “2023-08-18”, “95”, and “1425”. Moreover, it is further assumed that the relevant data of “bu”, “project”, “create_date”, “yield”, and “output” corresponding to the day before “2023-08-18” are respectively queried as “Shanghai”, “PRJA”, “2023-08-17”, “93”, and “1105”. In this case, the processor 604 may determine the above data obtained by query as the first query result QR1 in step S740.

Then, the processor 604 may organize the first query result QR1 into the second query result QR2 presented in the preset format based on the preset format.

In an embodiment of the disclosure, the second query result QR2 presented in the preset format may, for example, include one or a plurality of first data combinations, and each of the first data combinations includes a first query target and a first data corresponding to the first query target.

In an embodiment of the disclosure, the default format is, for example, the “{key:value}” format (the key may be understood as corresponding to the first query target, and the value may be understood as corresponding to the first data}), such as “[{‘key11’: ‘value11’, ‘key12’: ‘value12’, ‘key13’: ‘value13’, ‘key14’: ‘value14’, ‘key15’: ‘value15’}, {‘key21’: ‘value21’, ‘key22’: ‘value22’, ‘key23’: ‘value23’, ‘key24’: ‘value24’, ‘key25’: ‘value25’}]” shown in FIG. 8, but may be not limited thereto.

In this case, the second query result QR2 presented in the preset format correspondingly has the format shown in FIG. 8, such as “[{‘bu’: ‘Shanghai’, ‘project’: ‘PRJA’, ‘create_date’: ‘2023-08-18’, ‘yield’: 95, ‘output’: 1425}, {‘bu’: ‘Shanghai’, ‘project’: ‘PRJA’, ‘create_date’: ‘2023-08-17’, ‘yield’: 93, ‘output’: 1105}]”, but may be not limited thereto.

In step S750, the processor 604 evaluates the first validity of the first query syntax 802 provided by the first language model based on whether the second query result QR2 completely includes the second reference query result RR2.

In an embodiment, the processor 604 may determine that the first query syntax 802 provided by the first language model is valid in response to determining that the second query result QR2 completely includes the second reference query result RR2. In another embodiment, the processor 604 may determine that the first query syntax 802 provided by the first language model is invalid in response to determining that the second query result QR2 does not completely include the second reference query result RR2.

In the case of FIG. 8, since the second query result QR2 completely includes the second reference query result RR2 (i.e., “{‘project’: ‘PRJA’, ‘yield’: 95, ‘output’: 1425}, {‘project’: ‘PRJA’, ‘yield’: 93, ‘output’: 1105}”), the processor 604 may determine that the first query syntax 802 is valid.

In other embodiments, if the second query result QR2 does not completely include the second reference query result RR2 (for example, one or a plurality of “{‘project’: ‘PRJA’, ‘yield’: 95, ‘output’: 1425}, {‘project’: ‘PRJA’, ‘yield’: 93, ‘output’: 1105}” is missing), the processor 604 may determine that the first query syntax 802 is invalid.

From another point of view, as long as the content of the second query result QR2 covers all the information desired for query, even if the content of the first query syntax 802 is different from the content of the reference query syntax 801 and/or the second query result QR2 is not exactly the same as the second reference query result RR2, the processor 604 still determines that the first query syntax 802 is valid.

However, if the first language model is evaluated using any of the mechanisms shown in FIG. 1 to FIG. 3, the first query syntax 802 is misjudged as invalid because the content is different from the content of the reference query syntax 801 and/or the second query result QR2 is not exactly the same as the second reference query result RR2.

Therefore, it may be known that the method provided in an embodiment of the disclosure may better evaluate whether the language model may provide a suitable query syntax in response to the prompt.

In other embodiments, the processor 604 may also evaluate the validity of other language models based on a concept similar to FIG. 2, and may compare different language models based on the validity corresponding to the different language models.

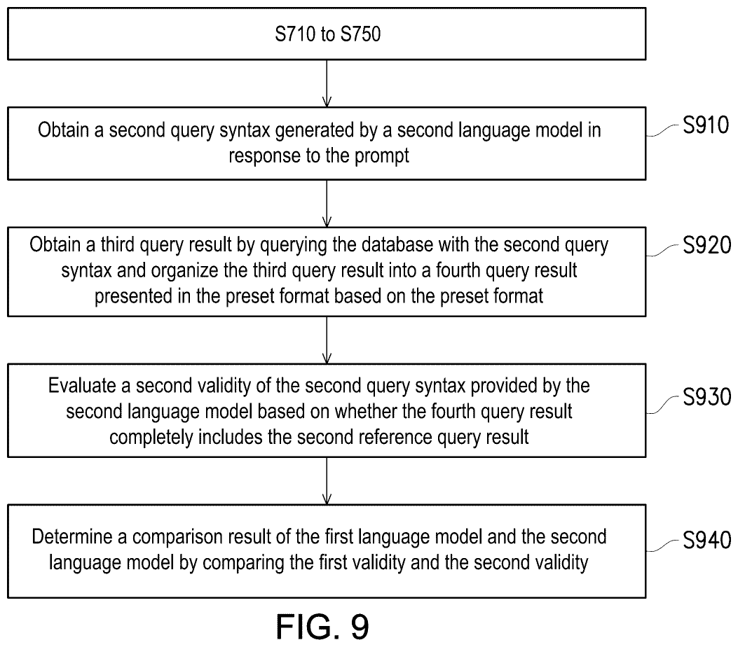

FIG. 9 is a flowchart of a method for evaluating a language model according to an embodiment of the disclosure. In the present embodiment, after the processor 604 executes steps S710 to S750, steps S910 to S940 may be further executed.

In step S910, the processor 604 obtains a second query syntax generated by a second language model in response to the prompt. In step S920, the processor 604 obtains a third query result by querying the database with the second query syntax, and organizes the third query result into a fourth query result presented in the preset format based on the preset format. In step S930, the processor 604 evaluates a second validity of the second query syntax provided by the second language model based on whether the fourth query result completely includes the second reference query result.

For details of steps S910 to S930, reference may be made to the details of steps S730 to S750 in previous embodiments, which is not described again here.

In step S940, the processor 604 determines a comparison result of the first language model and the second language model by comparing the first validity and the second validity.

For example, if the first query syntax is determined to be valid and the second query syntax is determined to be invalid, the processor 604 may determine, for example, that the first language model is better than the second language model. In contrast, if the first query syntax is determined to be invalid and the second query syntax is determined to be valid, the processor 604 may determine, for example, that the second language model is better than the first language model, but may be not limited thereto.

In an embodiment, the processor 604 may repeatedly execute steps S710 to S750 and S910 to S930 based on different prompts and corresponding reference query syntaxes to obtain a first statistical validity of different first query syntaxes generated by the first language model and a second statistical validity of different second query syntaxes generated by the second language model. For example, if M in K first query syntaxes generated by the first language model are determined to be valid, the first statistical validity of different first query syntaxes generated by the first language model may be characterized as M/K, for example. In addition, the processor 604 may determine the second statistical validity of different second query syntaxes generated by the second language model based on a similar concept, the details of which are not described again here.

Please refer to Table 1 below, which is a schematic diagram of evaluation results of evaluating different language models with different mechanisms shown according to an embodiment of the disclosure.

TABLE 1

| | LLaMA- | GPT 3.5 | |
|---|---|---|---|
| | 65 | turbo | Davinci-003 |
| Evaluation with the mechanism of | 0 | 0 | 0 |
| FIG. 1 | | | |
| Evaluation with the mechanism of | 12 (30%) | 12 (30%) | 11 (28%) |
| FIG. 3 | | | |
| Evaluation using the method of the | 14 (35%) | 25 (63%) | 13 (33%) |
| disclosure | | | |

In the case of Table 1, the evaluated language models include, for example, LLaMA-65, GPT 3.5 turbo, and Davinci-003, which may be evaluated using the methods of FIG. 1, FIG. 3, and the present application respectively.

In Table 1, the processor 604 may evaluate the above language models based on, for example, 40 groups of prompts and corresponding reference query syntaxes. As may be seen from Table 1, if the above language models are evaluated with the mechanism of FIG. 1, each language model may not provide any first query syntax that is sufficient to be determined as valid.

In addition, if the above language models are evaluated with the mechanisms of FIG. 3, then LLaMA-65, GPT 3.5 turbo, and Davinci-003 may have statistical validity of 30%, 30%, and 28% respectively. That is, under the condition of evaluating with the mechanisms of FIG. 3, LLaMA-65 provides 12 valid first query syntaxes in response to the 40 groups of prompts; GPT 3.5 turbo provides 12 valid first query syntaxes corresponding to the 40 groups of prompts; and Davinci-003 provides 11 valid first query syntaxes corresponding to the 40 groups of prompts.

If the above language models are evaluated with the mechanism provided in the present application, then LLaMA-65, GPT 3.5 turbo, and Davinci-003 may have statistical validity of 35%, 63%, and 33% respectively. That is, under the condition of evaluating with the method of the disclosure, LLaMA-65 provides 14 valid first query syntaxes in response to the 40 groups of prompts; GPT 3.5 turbo provides 25 valid first query syntaxes corresponding to the 40 groups of prompts; and Davinci-003 provides 13 valid first query syntaxes corresponding to the 40 groups of prompts. It may therefore be seen that the method provided in the disclosure may evaluate a language model more appropriately.

Based on the above, the method provided by the embodiment of the disclosure may take into account the query syntax and the corresponding query result generated by the language model at the same time, so as to better evaluate whether the language model may provide a suitable query syntax in response to the prompt.

In addition, the method of an embodiment of the disclosure may also provide a result having more practical interpretation meaning, thereby helping to understand the performance of the language model, and may also serve as a reference for the designer to improve the content of the prompt. In addition, the mechanism of an embodiment of the disclosure is simple and therefore may be reproduced and used in other studies.

Although the disclosure has been described with reference to the above embodiments, it will be apparent to one of the ordinary skill in the art that modifications and variations to the described embodiments may be made without departing from the spirit and scope of the disclosure. Accordingly, the scope of the disclosure will be defined by the attached claims not by the above detailed descriptions.

What is claimed is:

1. A method for evaluating a language model, executed by an electronic device, comprising:
obtaining a prompt and a reference query syntax corresponding to the prompt;
obtaining a first reference query result by querying a database with the reference query syntax and organizing the first reference query result into a second reference query result presented in a preset format based on the preset format;
obtaining a first query syntax generated by a first language model in response to the prompt;
obtaining a first query result by querying the database with the first query syntax and organizing the first query result into a second query result presented in the preset format based on the preset format;
evaluating a first validity of the first query syntax provided by the first language model based on whether the second query result completely comprises the second reference query result.

2. The method of claim 1, wherein the step of evaluating the first validity of the first query syntax provided by the first language model based on whether the second query result completely comprises the second reference query result comprises:
determining that the first query syntax provided by the first language model is valid in response to determining that the second query result completely comprises the second reference query result; and
determining that the first query syntax provided by the first language model is invalid in response to determining that the second query result does not completely comprise the second reference query result.

3. The method of claim 2, wherein the second reference query result comprises at least one reference data combination, each of the reference data combinations comprises a first reference query target and a first reference data corresponding to the first reference query target, the second query result comprises at least one first data combination, and each of the first data combinations comprises a first query target and a first data corresponding to the first query target.

4. The method of claim 1, wherein the reference query syntax is a correct database query syntax designed to query the database in response to the prompt.

5. The method of claim 1, further comprising:
obtaining a second query syntax generated by a second language model in response to the prompt;
obtaining a third query result by querying the database with the second query syntax and organizing the third query result into a fourth query result presented in the preset format based on the preset format;
evaluating a second validity of the second query syntax provided by the second language model based on whether the fourth query result completely comprises the second reference query result;
determining a comparison result of the first language model and the second language model by comparing the first validity and the second validity.

6. An electronic device, comprising:
a storage circuit storing a program code; and
a processor coupled to the storage circuit and accessing the program code to execute:
obtaining a prompt and a reference query syntax corresponding to the prompt;
obtaining a first reference query result by querying a database with the reference query syntax and organizing the first reference query result into a second reference query result presented in a preset format based on the preset format;
obtaining a first query syntax generated by a first language model in response to the prompt;
obtaining a first query result by querying the database with the first query syntax and organizing the first query result into a second query result presented in the preset format based on the preset format;
evaluating a first validity of the first query syntax provided by the first language model based on whether the second query result completely comprises the second reference query result.

7. The electronic device of claim 6, wherein the processor executes:
determining that the first query syntax provided by the first language model is valid in response to determining that the second query result completely comprises the second reference query result; and
determining that the first query syntax provided by the first language model is invalid in response to determining that the second query result does not completely comprise the second reference query result.

8. The electronic device of claim 7, wherein the second reference query result comprises at least one reference data combination, each of the reference data combinations comprises a first reference query target and a first reference data corresponding to the first reference query target, the second query result comprises at least one first data combination, and each of the first data combinations comprises a first query target and a first data corresponding to the first query target.

9. The electronic device of claim 6, wherein the reference query syntax is a correct database query syntax designed to query the database in response to the prompt.

10. The electronic device of claim 6, wherein the processor further executes:
obtaining a second query syntax generated by a second language model in response to the prompt;
obtaining a third query result by querying the database with the second query syntax and organizing the third query result into a fourth query result presented in the preset format based on the preset format;
evaluating a second validity of the second query syntax provided by the second language model based on whether the fourth query result completely comprises the second reference query result;
determining a comparison result of the first language model and the second language model by comparing the first validity and the second validity.
